(19) United States
(12) Patent Application Publication
(10) Pub. No.: US 2005/0041680 A1
(43) Pub. Date: Feb. 24, 2005

(54) L2 switch and control method therof

(76) Inventors: Keiji Tanaka, Kamifukuoka-shi (JP); Teruyuki Hasegawa, Kamifukuoka-shi (JP)

Correspondence Address: CHRISTIE, PARKER & HALE, LLP, PO BOX 7068, PASADENA, CA, 91109-7068, US

(21) Appl. No.: 10/919,911

(22) Filed: Aug. 16, 2004

(30) Foreign Application Priority Data
Aug. 18, 2003 (JP) 2003-294590

(51) Int. Cl. H04L 12/56

(52) U.S. Cl. 370/432; 370/390

(57) ABSTRACT

An L2 switch disposed between a multicast network and one or more user systems includes a switching engine having an input port to receive multicasted data from the multicast network and a plurality of output ports, the switching engine capable of delivering at least a part of the multicasted data from at least one of a plurality of data sources in the multicast network to one or more data-destination ports of the plurality of output ports; a transfer table to store corresponding relations between the at least one of the plurality of data sources and the one or more data-destination ports of the plurality of output ports; and a switching controller to update the transfer table according to a predetermined message that passes through the switching engine and to control the delivering of the multicasted data of the switching engine by referring to the transfer table. The switching controller limits a number of the plurality of data sources to be assigned to each output port of the switching engine within a predetermined number and refuses to update the transfer table for a delivery request that exceeds the predetermined number.

### CROSS REFERENCE TO RELATED APPLICATIONS

This application claims priority to Japanese Patent Application No. 2003-294590, filed Aug. 18, 2003, the entire contents of which are incorporated herein by reference.

### FIELD OF THE INVENTION

This invention relates to an L2 switch and a control method thereof.

### BACKGROUND OF THE INVENTION

In a data network represented by IP network, multicast has been spotlighted as a service to take the place of broadcasting or similar services. Although there is a similar service called video on demand (VoD), multicast has a merit to consume fewer bandwidth compared to VoD. IP multicast using IGMP (Internet Group Management Protocol) is described in Japanese Laid-Open Patent application Nos. 2001-521716, 2000-125277, 2000-134208, 2002-44132, and 2002-64558. Japanese Laid-Open Patent application No. 2001-521716 corresponds to International publication No. WO98/48343 and Japanese Laid-Open Patent application No. 2000-125277 corresponds to U.S. Pat. No. 6532233.

A layer 2 (the data link layer of OSI model) switch is generally built in an LAN switch and a router etc. Flooding of multicasted frames during multicast communication is known in the art as a weak point of Layer 2 switch.

One of the most effective methods for suppressing flooding of multicast traffics in a layer (L) 2 switch is IGMP snooping. In IGMP snooping, communication of IGMP between a host and an upper router is snooped to constantly update a transfer table (hereinafter, IGMP snooping table) that associates between a multicast address and a destination port. The update includes addition and deletion of entry. This operation suppresses unnecessary transfers in multicast traffics.

FIG. 3 shows a schematic block diagram of a conventional IP multicast system, and FIG. 4 shows a flow example of a multicast control using IGMP.

A multicast server 10 comprises, for example, a streaming server 10a and a video server 10b and connects to a router 14 in an IP multicast network 12. A datagram multicasted from the server 10 enters user systems 22 through a plurality of routers 14, 16, and 18 in the multicast network 12 and an L2 switch 20. A single L2 switch 20 generally connects to a plurality of user systems. Each of the user systems comprises specifically a personal computer or set-top box for receiving video data. Each of the user systems 22 may sometimes comprise another L2 switch and a personal computer and a set-top box connected to the L2 switch.

Multicast routing protocols such as a protocol PIM-SM (Protocol Independent Multicast-Sparse Mode) and a PIM-DM (Protocol Independent Multicast-Dense Mode) are used between the routers 14 and 16 and between the routers 16 and 18. The routers 14, 16, and 18 are a router, namely a multicast router to support multicast routing protocol. IGMP is used between the router 18 and the user systems 22.

In FIG. 4, four personal computers (PC) 22-1 to 22-4 are shown as examples of the user systems 22. The router 18 inquires respective PCs 22-1 to 22-4 for receiving state (for example, presence of received messages) at one-minute intervals using an IGMP General Query (GQ) message (S1, S4).

The PC 22-1 informs the router 18 as to a request for viewing ch 1 using an IGMP Membership Report (MR) message (S2). The L2 switch 20 snoops this MR message and stores it in an inner IGMP snooping table. The router 18 outputs a datagram of a required channel (here, ch 1) into the L2 switch 20 according to the entry request (S2), and the L2 switch 20 transfers the datagram only to the PC 22-1 referring to the IGMP snooping table (S3).

While viewing the ch 1, the PC 22-1 replies of its viewing state through MR (S5) within ten seconds to the inquiry through GQ at one-minute intervals from the router 18 (S4). When no PC 22 replies to inquiries of three times from the router 18, the router 18 stops multicasting to the assigned PCs 22 because such condition indicates a high possibility of either a fault in a network or power-off of the assigned PCs 22 without informing the termination of viewing.

When stopping the viewing of the ch 1, the PC 22-1 transmits an IGMP Leave Group message that means to leave from the viewing group of the ch 1 (S6). As soon as receiving the IGMP Leave Group message from the PC 22-1, the router 18 transmits an IGMP Group-Specific Query (GSQ) message to each of the PCs 22- to 22-4 (S7). One second after the transmission of the IGMP GSQ message to each of the PCs 22-1 to 22-4, the router 18 once again transmits an IGMP GSQ message of the same contents to each of the PCs 22-1 to 22-4 (S8).

When the router 18 does not receive any confirmation message of viewing from the PCs 22-1 to 22-4 within one second in spite of its inquiries of two times, the router 18 stops its transmission for the PCs 22-1 to 22-4, which are assigned to the L2 switch 20. The L2 switch 20 deletes the entry of Ch 1 from the IGMP snooping table when no PCs 22-1 to 22-4 transmits a message to confirm the viewing of the Ch 1 within a predetermined period, which is 3 seconds or more, from the transmission of the first GSQ message.

In an IP multicast network using IGMP, it requires 2 seconds or more for an upper router to stop transferring of multicast traffics after a host transmits an IGMP Leave Group message because of the default setting of protocols. Accordingly, the update period of the IGMP snooping table in the L2 switch is generally set longer than that, i.e. 3 seconds or more.

The number of multicast addresses to be stored in the IGMP snooping table is limited, and users connected to respective ports use the table together. Therefore, it is crucial to remove unnecessary addresses that are not being used as soon as possible.

In the multicast, channel changes may occur several times during a table-updating period. For instance, viewing channels are sometimes circularly switched at a high-speed. This is equivalent to zapping in a TV broadcast.

In a conventional system to control multicast traffics only through updating of the IGMP snooping table, when several channel changes are carried out during a table-updating period, it causes the following problems. That is:

First, multicast addresses equivalent to the number of channel changes performed during an updating period of an IGMP snooping table are stored in the IGMP snooping table and accordingly the limited IGMP snooping table is consumed.

Secondly, if a malicious user continuously transmits IGMP frame during an updating period of an IGMP snooping table, the IGMP snooping table overflows. As a result, transferring of multicast traffics to the other users is jammed. So-called DoS (Denial of Service) attacks are possible.

Thirdly, bandwidth of a trunk line connected to the upper apparatuses of the L2 switch are wasted because the multicast traffics of the addresses having stored due to the zapping are all transferred. When a transfer request of the multicast traffics larger than the bandwidth of the trunk line, all the traffics connecting to any port are adversely affected due to the congestion of the trunk line.

Fourthly, under the circumstances, no new user can receive the multicast because it is unable to add a new entry to nor to update the IGMP snooping table. In other words, only the existing users (ports) can use the limited multicast addresses and accordingly the fairness between the ports (users) is completely collapsed.

### SUMMARY OF THE INVENTION

According to the invention, an L2 switch disposed between a multicast network and user system comprises a switching engine having an input port to receive data multicasted from the multicast network and a plurality of output ports, the switching engine capable of delivering a multicasted data from a data source in the multicast network to one or more output ports, a transfer table to store corresponding relations between the data source and one or more data-destination ports of the plurality of output ports, and a switching controller to update the transfer table according to a predetermined message that passes through the switching engine and to control the delivering of the switching engine referring to the transfer table. The switching controller limits the number of data sources to be assigned to each output port of the switching engine within a predetermined number and refuses to update the transfer table for a delivering request that exceeds the predetermined number.

According to the invention, an L2 switch control method to control an L2 switch disposed between a multicast network and user systems comprises updating a transfer table that stores corresponding relation between data source of data multicasted from the multicast network and one or more data destination ports of a switching engine according to a predetermined message that passes through the switching engine of the L2 switch, controlling the delivering of the switching engine referring to the transfer table, and limiting the number of data sources to be assigned to each port of the switching engine on the transfer table within a predetermined number and refusing to update the transfer table for a delivering request that exceeds the predetermined number.

According to the invention, it is possible to impartially assign multicast addresses to each user by limiting the number of data sources to be assigned to each output port of the switching engine. Furthermore, DoS attacks by a certain user can be prevented.

### BRIEF DESCRIPTION OF THE DRAWINGS

The above and other objects, features and advantages of the present invention will be apparent from the following detailed description of explanatory embodiments of the invention in conjunction with the accompanying drawings, in which:

FIG. 1 shows a schematic block diagram of an L (layer) 2 switch according to an explanatory embodiment of the invention;

FIG. 2 shows an example of anIGMP snooping transfer table 34;

FIG. 3 shows a schematic diagram of a conventional IP multicast system; and

FIG. 4 shows a flow example of multicast control using IGMP.

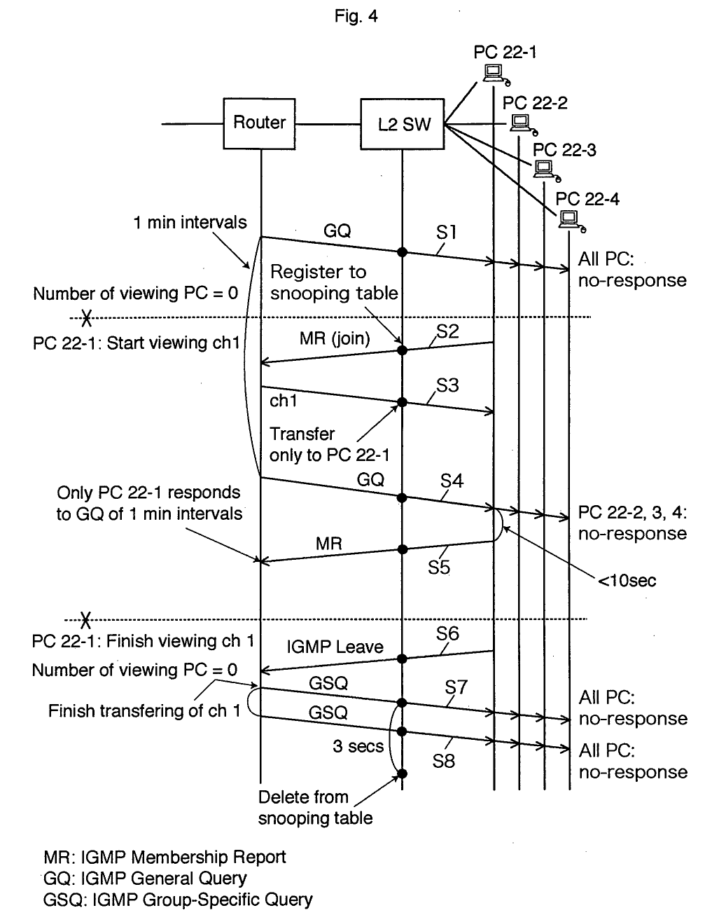

### DETAILED DESCRIPTION

Explanatory embodiments of the invention are explained below in detail with reference to the drawings.

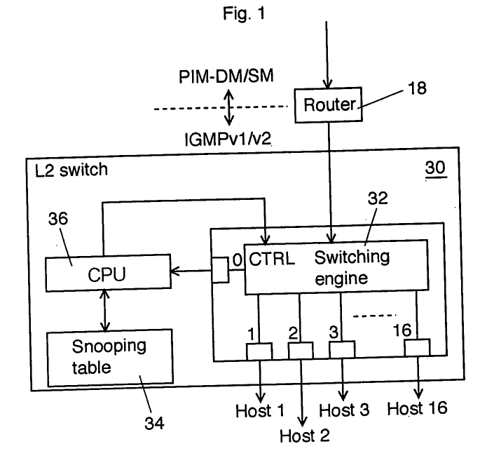

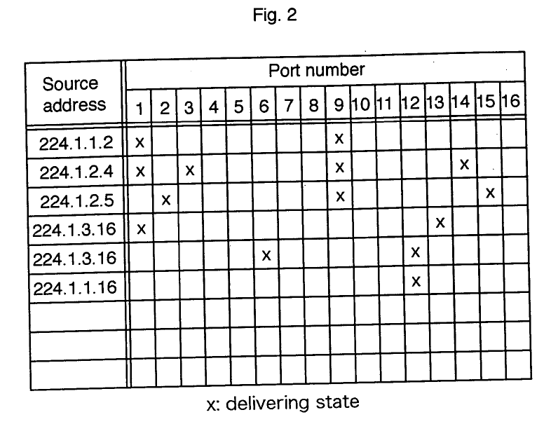

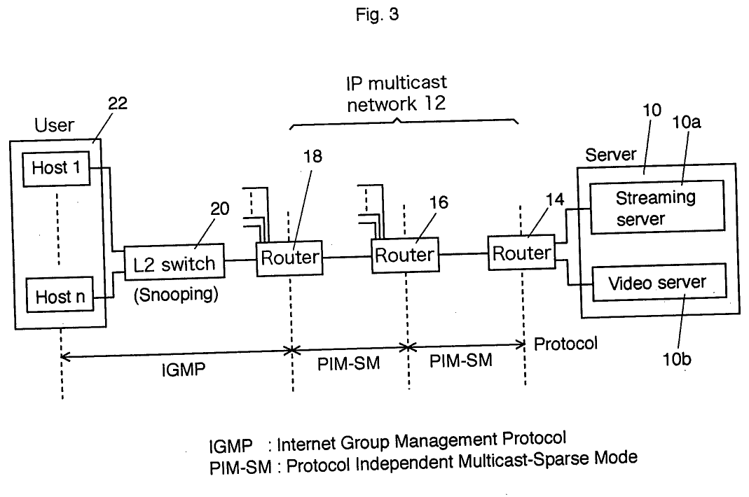

FIG. 1 shows a schematic block diagram of an L (layer) 2 switch according to an explanatory embodiment of the invention. FIG. 2 shows an example of an IGMP snooping transfer table used in the L2 switch shown in FIG. 1. An L2 switch 30 shown in FIG. 1 is disposed on the corresponding position where an L2 switch 20 shown in FIG. 3 is disposed.

The L2 switch 30 is composed of a switching engine 32 to actually deliver MAC frames between input ports and output ports, an IGMP snooping table 34, and a CPU (or switch controller) 36 to update the IGMP snooping table 34 and to control the switching engine 32 according to the contents of the IGMP snooping table 34.

The switching engine 32 snoops IGMPs communicated between a router 18 and user systems (host 1 to host 16) and informs it to the CPU 36 through a port 0. The CPU 36 updates the IGMP snooping table 34 according to the data snooped by the switching engine 32.

The CPU 36 uses and controls the IGMP snooping table 34 as follows:

First, the CPU 36 limits the number of addresses to be entered the IGMP snooping table 34 and refuses entry of new addresses that exceeds a predetermined maximum entry number. For instance, even if the IGMP snooping table 34 is capable of storing 64 entries, the CPU 36 sets the number of acceptable entries as 60 according to a line capacity on the upper stream. For instance, for a trunk line of 100 Mbps, the trunk line is congested if 15 users try to receive a 7 Mbps datagram of different channels all at once. In such case, the maximum entry number should be limited to 10. When multicast service including broadcasting is provided, it is possible to avoid the congestion of the trunk line by limiting the acceptable entry to only static addresses and the maximum entry number to 10.

Although the remaining entries can be left as unused, it is also applicable, for example, to keep them in the multicast as extra entries for prior uses (such as disasters, severe accidents, and events that should be broadcasted to the community urgently). The CPU 36 adds address of the prior multicast to extra entry of the IGMP snooping table 34 according to a control signal from a multicast server or administrative terminal.

Secondly, in the IGMP snooping table 34, as shown in FIG. 2, multicast source addresses are entered, and each entry can have a flag to indicate an ON/OFF state of delivering for each host (ports 1 to 16) connecting with the L2 switch 30. An “x” sign in FIG. 2 means that a datagram is being delivered from a source address written on the corresponding line to a port on the corresponding column. Compared to a table format that makes one-by-one correspondence between a source address and a port number to receive a datagram, this format can suppress the increase of entry numbers and therefore make control of entry numbers much easier. It is also easy to control the number of receiving hosts of the same channel.

Thirdly, the CPU 36 trashes a frame or datagram of a new address refused to enter without broadcasting. That is, the L2 switch 30 trashes a frame or datagram of a multicast address not entered the IGMP snooping table without broadcasting. This operation prevents network bandwidth, especially the network bandwidth between the L2 switch and user systems, from being wasted.

Fourthly, the CPU 36 limits acceptable entries of multicast traffic addresses to a fixed number (three in the example shown in FIG. 2) for each of the input/output ports 1 to 16 of the switching engine 32. When a request (IGMP Join message) that exceeds the predetermined number is received, the CPU 36 refuses the request. For instance, in the example shown in FIG. 2, a host of port 9 is already receiving three channels. When the maximum number is limited to three, a new request of the host of port 9 to receive another channel is refused. For example, even if a user system connecting to the port 9 requests to receive a multicast data from an address 224.1.3.16 which has been entered the table 34, the CPU 36 does not stand a flag on the corresponding location on the table 34.

By limiting the number of viewing channels as stated above, it is possible to impartially assign multicast addresses to each user. For instance, when zapping that viewers change channels several times in a short period is performed during commercial messages etc., entries of the IGMP snooping table 34 are quickly consumed. This means that the other users lose opportunities of viewing. Assuming that the number of addresses added by zapping is 10 per second, and three users zap together to add new entries of all different addresses to the table 34, as many as 90 entries of new addresses are required from zapping of the three users. However, by limiting the number of acceptable entries of each port to three, for example, newly added addresses are limited to nine at the maximum even if the same zapping is carried out and therefore the consumption of the table 34 can be suppressed. This is also effective to prevent DoS attacks by a certain user.

It is possible for each user to dispose another L2 switch under the L2 switch 30. If there is no restriction about an entry method and the number of entry addresses, a single user or a few users can monopolize all the usable multicast addresses under the rule of FIFO (First-In First-Out). As stated above, such monopoly is prevented by limiting the number of receivable addresses at each port. The CPU 36 refuses to add a new address that exceeds the maximum address number at each port.

While the invention has been described with reference to the specific embodiment, it will be apparent to those skilled in the art that various changes and modifications can be made to the specific embodiment without departing from the spirit and scope of the invention as defined in the claims.

1. An L2 switching apparatus disposed between a multicast network and one or more user systems, the apparatus comprising:
a switching engine having an input port to receive multicasted data from the multicast network and a plurality of output ports, the switching engine for delivering at least a part of the multicasted data from a data source in the multicast network to one or more data-destination ports of the plurality of output ports or more output ports;
a transfer table to store corresponding relations between the data source and the one or more data-destination ports of the plurality of output ports; and
a switching controller to update the transfer table according to a predetermined message that passes through the switching engine and to control the delivering of the multicasted data of the switching engine by referring to the transfer table; wherein
the switching controller limits a number of a plurality of data sources to be assigned to each output port of the switching engine within a predetermined number and refuses to update the transfer table for a delivery request that exceeds the predetermined number.

2. The apparatus of claim 1 wherein the predetermined number of the transfer table is variable.

3. The apparatus of claim 1 wherein the transfer table stores for each data source an indication on whether a datagram is being delivered to each of the one or more data-destination ports of the switching engine connectable to the user systems.

4. An L2 switch control method to control an L2 switch disposed between a multicast network and user systems, the method comprising:
updating a transfer table that stores a corresponding relation between a data source of multicasted data from the multicast network and one or more data destination ports of a switching engine according to a predetermined message that passes through the switching engine of the L2 switch;
controlling a delivery of the switching engine of the multicasted data by referring to the transfer table;
limiting a number of data sources to be assigned to each of the destination ports of the switching engine on the transfer table within a predetermined number; and
refusing to update the transfer table for a delivery request that exceeds the predetermined number.

5. The method of claim 4 further comprises updating the predetermined number of the transfer table according to a bandwidth of a predetermined location in the multicast network.

6. The method of claim 4 wherein the transfer table stores for each data source an indication on whether a datagram is being delivered to each of the one or more destination ports of the switching engine connectable to the user systems.

7. The apparatus of claim 1 wherein the transfer table comprises an Internet Group Management Protocol (IGMP) snooping table.

8. The apparatus of claim 1 wherein the switching controller comprises a central processing unit (CPU).

9. The apparatus of claim 1 wherein the switching engine snoops a plurality of Internet Group Management Protocol (IGMP) communications between a router and the one or more user systems to generate the predetermined message.

10. The apparatus of claim 1 wherein the multicasted data comprises a plurality of media access control (MAC) frames.

11. The apparatus of claim 2 wherein the switching controller limits the number of the data sources according to a trunk line capacity.

12. The apparatus of claim 3 wherein the indication comprises a flag and wherein the switching controller limits the number of the data sources by limiting a number of the flags associated to each of the one or more data-destination ports.

13. The method of claim 4 wherein the transfer table comprises an Internet Group Management Protocol (IGMP) snooping table.

14. The method of claim 4 wherein the updating of the transfer table comprises snooping a plurality of Internet Group Management Protocol (IGMP) communications between a router and the user systems to generate the predetermined message.

15. The method of claim 6, wherein at least one of the user systems comprises a personal computer (PC).

16. An L2 switch disposed between a multicast network and one or more user systems, the L2 switch comprising:
means for updating a transfer table that stores one or more corresponding relations between one or more data sources for multicasting data over the multicast network and one or more data destination ports of a switching engine according to a predetermined message that passes through the switching engine of the L2 switch;
means for controlling a delivery of the switching engine of the multicasted data by referring to the transfer table;
means for limiting a number of the one or more data sources to be assigned to each of the one or more destination ports of the switching engine on the transfer table within a predetermined number; and
means for refusing to update the transfer table for a delivery request that exceeds the predetermined number.

17. The L2 switch of claim 16 wherein the transfer table comprises an Internet Group Management Protocol (IGMP) snooping table.

18. The L2 switch of claim 16 wherein the controlling means comprises a central processing unit (CPU).

19. The L2 switch of claim 16, further comprising:
means for snooping a plurality of Internet Group Management Protocol (IGMP) communications between a router and the user systems to generate the predetermined message.

20. The L2 switch of claim 16 wherein the controlling means comprises a plurality of flags and wherein limiting means comprises means for limiting a number the flags associated to each of the one or more data-destination ports.
